(19) United States
(12) Patent Application Publication
(10) Pub. No.: US 2015/0178274 A1
(43) Pub. Date: Jun. 25, 2015

(54) SPEECH TRANSLATION APPARATUS AND SPEECH TRANSLATION METHOD

(71) Applicant: KABUSHIKI KAISHA TOSHIBA, Tokyo (JP)

(72) Inventor: Hiroyuki TANAKA, Chigasaki Kanagawa (JP)

(73) Assignee: KABUSHIKI KAISHA TOSHIBA, Tokyo (JP)

(21) Appl. No.: 14/581,944

(22) Filed: Dec. 23, 2014

(30) Foreign Application Priority Data
Dec. 25, 2013 (JP) 2013-267918

(51) Int. Cl. G06F 17/28; G10L 15/00

(52) U.S. Cl. CPC G06F 17/28; G10L 15/005

(57) ABSTRACT

According to an embodiment, a speech translation apparatus includes an allocator, a searcher and a sorter. The allocator allocates, to each of the phrases in the set of phrases, a weight dependent on a difference between a current dialog status and a dialog status associated with an original speech sound that corresponds to a text in which each of the phrases appears. The searcher searches the plurality of examples in the first language for an example including one or more phrases included in the set of phrases to obtain a hit example set. The sorter calculates a score of each of hit examples included in the hit example set based on the weight and the degree of similarity to sort the hit examples based on the score.

### CROSS-REFERENCE TO RELATED APPLICATIONS

This application is based upon and claims the benefit of priority from Japanese Patent Application No. 2013-267918, filed Dec. 25, 2013, the entire contents of which are incorporated herein by reference.

### FIELD

The embodiments disclosed herein relate to an example search technique related to speech translation technology.

### BACKGROUND

Recently, there are more and more opportunities for communication between people who speak different languages as cultural and economic globalization progresses. As a consequence, automatic interpretation technology that is useful for such communication has drawn more attention. Particularly, with speech translation technology, which is an application of natural language processing techniques and machine translation techniques, the audio input of an original sentence in a speaker's language is machine-translated into another language, and the translated sentence is presented to the speaker's conversation partner. Such speech translation technology enables people who speak different languages to communicate in a speech-based manner.

In conjunction with the speech translation technology, an example search technique is also utilized in communication between speakers of different languages. With the example search technique, one or more examples semantically similar to an original sentence in a first language that is entered via audio are searched from a plurality of prepared examples. The searched similar examples are presented to a speaker. When the speaker selects one of the presented similar examples, a translation of the selected similar example is presented to the person to whom the speaker's conversation partner. Accordingly, even in a case where the speech recognition result of the original sentence is inaccurate, as long as the speaker can select an appropriate example, the speaker is able to convey their idea accurately without rephrasing the original sentence. Therefore, it is important to present appropriate examples (i.e., examples with the highest possibility of matching what the speaker wants to communicate) to the speaker on a priority basis.

### BRIEF DESCRIPTION OF THE DRAWINGS

FIG. 1 is a block diagram showing the speech translation apparatus according to the first embodiment.

FIG. 2 shows an example of a dialog history stored in the dialog history storage shown in FIG. 1.

FIG. 3 shows an example of content of speech sound, a result of speech recognition of the speech sound, and a result of machine translation of the speech recognition result.

FIG. 4 shows a set of phrases extracted by the phrase extractor shown in FIG. 1.

FIG. 5 shows an example of weights allocated to each phrase in the set of phrases shown in FIG. 4.

FIG. 6 shows hit examples searched by the example searcher shown in FIG. 1, and weight scores, similarity scores, and search scores of the hit examples.

FIG. 7 shows a result of hit examples sorting performed by the example sorter shown in FIG. 1.

FIG. 8 shows an example display of hit examples and a result of machine translation performed by the presentation unit shown in FIG. 1.

FIG. 9 is a flowchart showing the operation of the speech translation apparatus shown in FIG. 1.

FIG. 10 is a flowchart of the example search process in FIG. 9.

FIG. 11 shows an example of a dialog history stored in the dialog history storage shown in FIG. 1.

FIG. 12 shows an example of content of speech sound, a result of speech recognition of the speech sound, and a result of machine translation of the speech recognition result.

FIG. 13 shows an example of a set of phrases extracted by the phrase extractor in the speech translation apparatus according to the second embodiment.

FIG. 14 shows an example of a set of phrases further extracted by the phrase extractor of the speech translation apparatus according to the second embodiment from a second candidate text of the machine translation result shown in FIG. 11, and a second candidate text of the speech recognition result shown in FIG. 12.

FIG. 15 shows an example of weights allocated to each phrase in the set of phrases shown in FIG. 13 or FIG. 14.

FIG. 16 shows hit examples searched by the example searcher of the speech translation apparatus according to the second embodiment, and weight scores, similarity scores, and search scores of the hit examples.

FIG. 17 shows a result of hit example sorting performed by the example sorter of the speech translation apparatus according to the second embodiment.

### DETAILED DESCRIPTION

Embodiments will be described hereinafter with reference to drawings.

According to an embodiment, a speech translation apparatus includes a speech recognizer, a machine translator, a first storage, an extractor, an allocator, a second storage, a searcher, a calculator and a sorter. The speech recognizer performs a speech recognition process on a current speech sound to generate a current speech recognition result. The machine translator performs machine translation from a first language to a second language on the current speech recognition result to generate a current machine translation result. The first storage stores a dialog history for each of one or more speeches constituting a current dialog. The extractor extracts a phrase from a text group to obtain a set of phrases. The text group includes the current speech recognition result, a past speech recognition result and a past machine translation result both included in the dialog history. The allocator allocates, to each of the phrases in the set of phrases, a weight dependent on a difference between a current dialog status and a dialog status associated with an original speech sound that corresponds to a text in which each of the phrases appears. The second storage stores a plurality of examples in the first language and translations in the second language, each of the translations corresponding to each of the examples in the first language. The searcher searches the plurality of examples in the first language for an example including one or more phrases included in the set of phrases to obtain a hit example set. The calculator calculates, for each of the hit examples included in the hit example set, a degree of similarity between the hit example and the current speech recognition result. The sorter calculates a score of each of the hit examples included in the hit example set based on the weight and the degree of similarity to sort the hit examples based on the score.

In the drawings, the same constituent elements are denoted by the same respective reference numbers, therefore redundant explanations will be omitted.

In the following explanation, speaker A speaks English and speaker B speaks Japanese. The Japanese texts are transcribed in Romanized Japanese (so-called romaji) for convenience. However, the languages used by speaker A and speaker B are not limited to English or Japanese; various languages can be used in the embodiment.

### First Embodiment

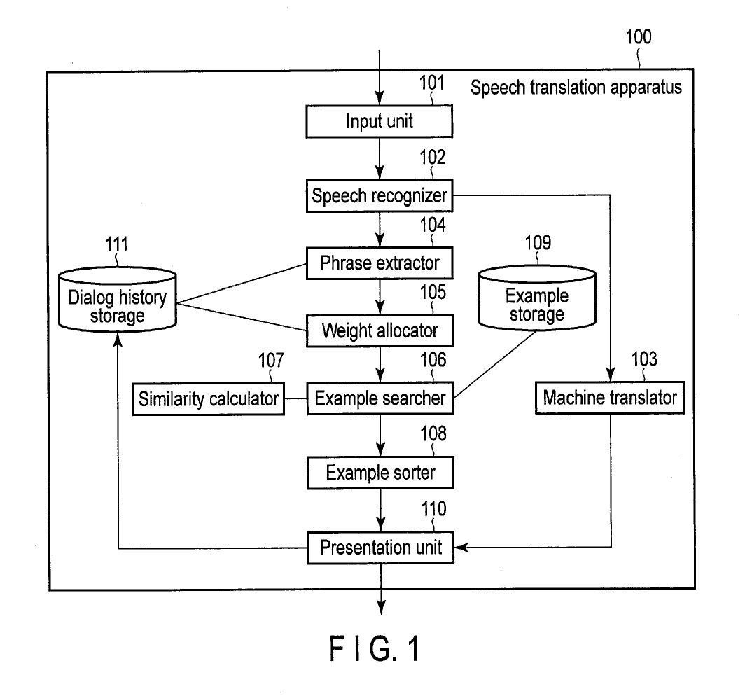

As shown in FIG. 1, the speech translation apparatus 100 comprises an input unit 101, a speech recognizer 102, a machine translator 103, a phrase extractor 104, a weight allocator 105, an example searcher 106, a similarity calculator 107, an example sorter 108, an example storage 109, a presentation unit 110, and a dialog history storage 111.

The input unit 101 inputs a speaker's spoken audio in a format of a digital audio signal. A existing audio input device, such as a microphone, may be used as an input unit 101. The input unit 101 outputs the digital audio signal to the speech recognizer 102.

The speech recognizer 102 receives the digital audio signal from the input unit 101. The speech recognizer 102 performs a speech recognition process on the digital audio signal to generate a speech recognition result in a text format expressing the content of the speech sound. When speaker A says “It was a green bag.”, for example, the speech recognizer 102 may generate a speech recognition result that perfectly corresponds to what speaker A said, or may generate a partly wrong speech recognition result, such as “It was a green back.”, as shown in FIG. 3.

The speech recognizer 102 can perform a speech recognition process by utilizing various methods, such as LPC (linear predictive coding) analysis, HMM (hidden Markov model), dynamic programming, neutral network, N-gram language model, etc. The speech recognizer 102 outputs the current speech recognition result to the machine translator 102 and the phrase extractor 104.

The machine translator 103 receives the current speech recognition result from the speech recognizer 102. The machine translator 103 performs machine translation on the speech recognition result which is in a text format in a first language (may be referred to as a source language) into a text in a second language (may be referred to as a target language) to generate a machine translation result in a text format. As shown in FIG. 3, when the speech recognition result is “It was a green back.”, the machine translator 103 may generate “Midori no koubu deshi ta. (It was a green back.)” as a machine translation result.

The machine translator 103 can perform machine translation by utilizing various methods, such as the transfer method, the example-base method, the statistical method, intermediate method, etc., which are adopted in a common machine translation system. The machine translator 103 outputs the current machine translation result to the presentation unit 110.

A dialog history for each of one or more speeches constituting the current dialog is written in the dialog history storage 111 by the presentation unit 110 (described later) in an order of occurrence of the speeches in the current dialog. Herein, the term “dialog” means a sequence of one or more speeches organized in the order of occurrence. Particularly, in a sequence corresponding to the current dialog, a newest element is the current speech, and the other elements in the sequence are the past speeches.

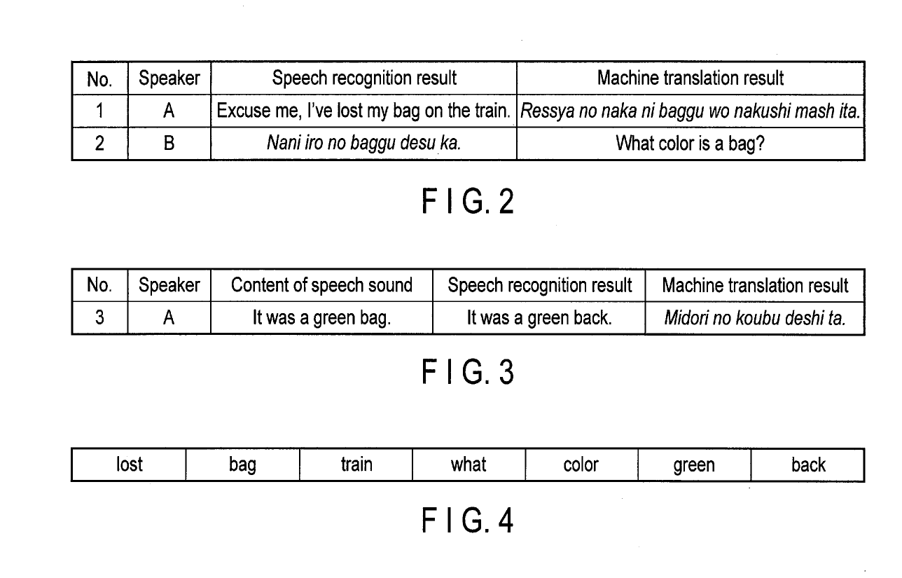

The dialog history storage 111 stores the written dialog history in a database format. The dialog history includes, for example, all or some of information identifying a speaker of the speech sound, a speech recognition result of the speech sound, a machine translation result of the speech recognition result, and an example selected instead of the machine translation result and a translation thereof (details described later). For example, the dialog history storage 111 stores the dialog history shown in FIG. 2. The dialog history stored in the dialog history storage 111 is read by the phrase extractor 104 and the weight allocator 105, as needed.

The phrase extractor 104 receives the current speech recognition result from the speech recognizer 102. The phrase extractor 104 further reads the dialog history from the dialog history storage 111. Specifically, the phrase extractor 104 receives the speech recognition results of the past speech sound in the first language and the machine translation results in the first language of the speech recognition results of the past speech sound in the second language included in the dialog history. The phrase extractor 104 extracts phrases from the text group containing these speech recognition results and machine translation results to obtain a set of phrases. The phase extractor 104 outputs the set of phrases to the weight allocator 105.

The phrase extractor 104 can extract phrases using, for example, morphological analysis and a word dictionary. General (not characteristic) words that appear in any text, such as “the” and “a” in English, may be registered as stop words. The phrase extractor 104 can exclude such stop words when extracting phrases in order to adjust the number of phrases included in the set of phrases so that the set does not become too large.

For example, the phrase extractor 104 obtains the set of phrases shown in FIG. 4 by extracting phrases from the speech recognition result of the speech sound by speaker A shown in FIGS. 2 and 3 and the machine translation result of the speech recognition result of the speech sound by speaker B shown in FIG. 2. Specifically, the phrase extractor 104 extracts phrases, such as “color” from the machine translation result of the speech recognition result of the past speech sound by speaker B, the phrase “lost” from the speech recognition result of the past speech sound by speaker A, and the phrase “green” from the speech recognition result of the current speech sound by speaker A.

The weight allocator 105 receives the set of phrases from the phrase extractor 104, and reads the dialog history from the dialog history storage 111. The weight allocator 105 allocates, to each of the phrases in the set, a weight dependent on a difference between a current dialog status and a dialog status associated with the original speech sound that corresponds to the text (i.e., a speech recognition result or a machine translation result) in which each of the phrases appears. A dialog status is, for example, a speaker of the speech sound, and the order of occurrence of the speech sound in the current dialog.

The weight allocator 105, if a phrase appears in a plurality of texts, calculates a weight for the phrase by summing weights dependent on a difference between a dialog status associated with an original speech sound that corresponds to each of the plurality of texts and a current dialog status. The weight allocator 105 outputs the set of phrases and weights allocated to the phrases in the set to the weight allocator 105.

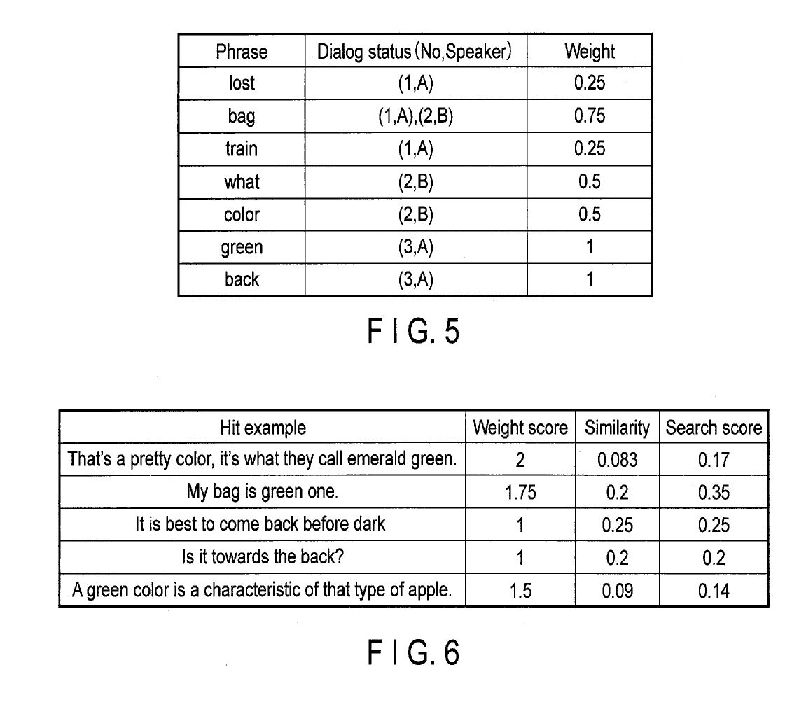

Specifically, the weight allocator 105 can allocate a weight to each of the phrases in the set in FIG. 4 as shown in FIG. 5.

The phrase “green” appears in the speech recognition result of the speech sound of speaker A in chronological order “3”, and the dialog status associated with the speech corresponds to the current dialog status. The weight allocator 105 allocates a weight “1” dependent on the difference between these dialog statuses to the phrases “green”.

The phrase “color” appears in the machine translation result of the speech recognition result of the speech sound of speaker B in chronological order “2”. The dialog status associated with the speech sound indicates that the speaker is different from that of the current dialog status, and the order of occurrence is one speech earlier than the current speech. The weight allocator 105 allocates, to the phrase “color”, a weight of “0.5” that is dependent on the difference between those dialog statuses.

The phrase “lost” appears in the speech recognition result of the speech sound of speaker A in chronological order “1”. The dialog status associated with the speech indicates the same speaker, but the chronological order is two speeches earlier than the current speech. The weight allocator 105 allocates, to the phrase “lost”, a weight of “0.25” that is dependent on the difference between those dialog statuses.

The phrase “bag” appears in the speech recognition result of the speech sound of speaker A in chronological order “1”, and the dialog status associated with the speech indicates the same speaker, but the order of occurrence is two speeches earlier than the current speech. The phrase “bag” further appears in the machine translation result of the speech recognition result of the speech sound of speaker B at chronological order “2”, and the dialog status associated with the speech indicates a different speaker from that of the current dialog status and that the order of occurrence is one speech earlier than the current speech. The weight allocator 105 allocates, to the phrase “bag”, a weight of “0.75”, which is obtained by summing “0.25” and “0.5” that is dependent on the difference between those dialog statuses.

The example storage 109 stores a plurality of examples in the first language and the translations thereof in the second language in a database format. The examples and translations stored in the example storage 109 are read by the example searcher 106, as needed.

The example searcher 106 receives the set of phrases and the weights allocated to the phrases in the set from the weight allocator 105. In order to obtain a set of hit examples, the example searcher 106 searches a plurality of examples in the first language stored in the example storage 109 for an example in the first language containing one or more phrases included in the phrase set. The example searcher 106 outputs the hit example set to the similarity calculator 107.

The example searcher 106 can search the plurality of examples in the first language stored in the example storage 109 for an example that includes one or more phrases contained in the phrase set, using an arbitrary text search method. For example, the example searcher 106 sequentially reads the plurality of examples in the first language stored in the example storage 109 to perform a keyword matching process for all the examples, or to index the examples by generating an inverted index.

Furthermore, the example searcher 106 calculates a weight score for each hit example included in the hit example set. Specifically, the example searcher 106 sums a weight allocated to at least one phrase included in a given hit example of the phrases contained in the phrase set to calculate a weight score for the hit example. The example searcher 106 outputs the hit example set and the weight scores to the example sorter 108.

For example, the phrases “bag” and “green” are included in the hit example, “My bag is green one.” Therefore, the example searcher 106 calculates the weight “1.75” for the hit example by summing the weight “0.75” allocated to the phrase “bag” and the weight “1” allocated to the phrase “green”.

The similarity calculator 107 receives the hit example set from the example searcher 106, and receives the current speech recognition result from the speech recognizer 102. The similarity calculator 107 calculates a degree of similarity between a hit example and a current speech recognition result for each hit example included in the hit example set. The example searcher 107 outputs the degree of similarity of each hit example to the example sorter 108.

The similarity calculator 107 calculates a degree of similarity using an arbitrary technique for searching similar sentences. For example, the similarity calculator 107 may calculate a degree of similarity using edit distance or a thesaurus, and may calculate a degree of similarity by summing the number of times when each of one or more words obtained by dividing a current speech recognition result word-by-word appears in a hit example.

FIG. 6 shows the degrees of similarity between each hit example included in the hit example set and the current speech recognition result, “It was a green back.”, shown in FIG. 3. The degrees of similarity shown in FIG. 6 are calculated using an edit distance normalized between 0 and 1. Specifically, the similarity calculator 107 calculates a degree of similarity (i) between the ith hit example Hᵢ (i denotes index) and a speech recognition result T by the following expression (1):

$$DegreeofSimilarity ( i ) = 1 - \frac{Edit Distance}{Max \{ WordLength ( T ) , WordLength ( {H}_{i} ) \}} \qquad ( 1 )$$

In Expression (1), WordLength(t) is a function that returns a word length of a text t, and Max(a,b) is a function that returns a larger one of values a and b.

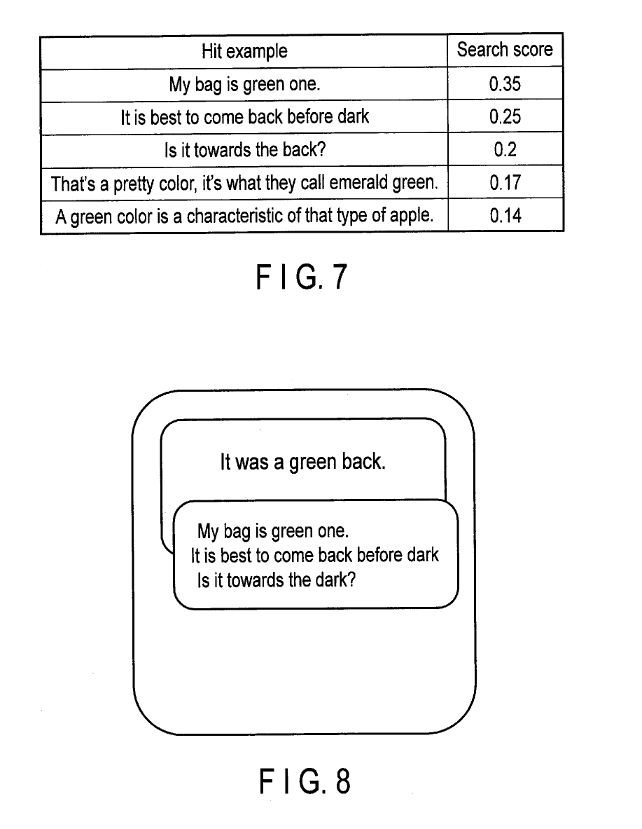

The example sorter 108 receives the hit example set and the weight scores from the example searcher 106, and receives the degrees of similarity of the hit examples from the similarity calculator 107. The example sorter 108 allocates, to each hit example included in the hit example set, a search score obtained by performing a certain calculation based on the weight score and the degree of similarity. For example, the example sorter 108 can use a product obtained by multiplying the weight score with the degree of similarity as shown in FIG. 6 as a search score for the hit example. Then, the example sorter 108 sorts the hit examples in the descending order of search scores as shown in FIG. 7. The example searcher 108 outputs a result of hit example sorting to the presentation unit 110.

The presentation unit 110 receives the current speech recognition result from the speech recognizer 102, receives the current machine translation result from the machine translator 103, and receives the result of hit example sorting from the example sorter 108. The presentation unit 110 presents all or a part of the current speech recognition result and the result of hit example sorting to the current speaker as shown in FIG. 8. The presentation unit 110 can display those texts using a display device, or audio-outputs the audio of the texts using an audio output device, such as a speaker.

Specifically, the presentation unit 110 may select and present the first through the rth (r is a natural number; it can be predetermined or designated by a user (e.g., one of the people speaking)) results of the hit example sorting, or may select and present the results having a search score equal to or greater than a threshold (which may be predetermined or designated by a user). Or, the presentation unit 110 may select a result of the hit example sorting in accordance with a combination of multiple conditions.

When the current speaker selects one of the plurality of texts presented to them using, for example, an input device, the presentation unit 110 presents (typically, displays or audio-outputs) the translation of the selected text (i.e., the current machine translation result or the translation of the selected example). Furthermore, when the current speaker selects the current speech recognition result, the presentation unit 110 writes information identifying the speaker, the current speech recognition result, and the current machine translation result to the dialog history storage 111. On the other hand, when the current speaker selects one of the presented examples, the presentation unit 110 writes information identifying the speaker, the selected example, and the translation of the selected example to the dialog history storage 111.

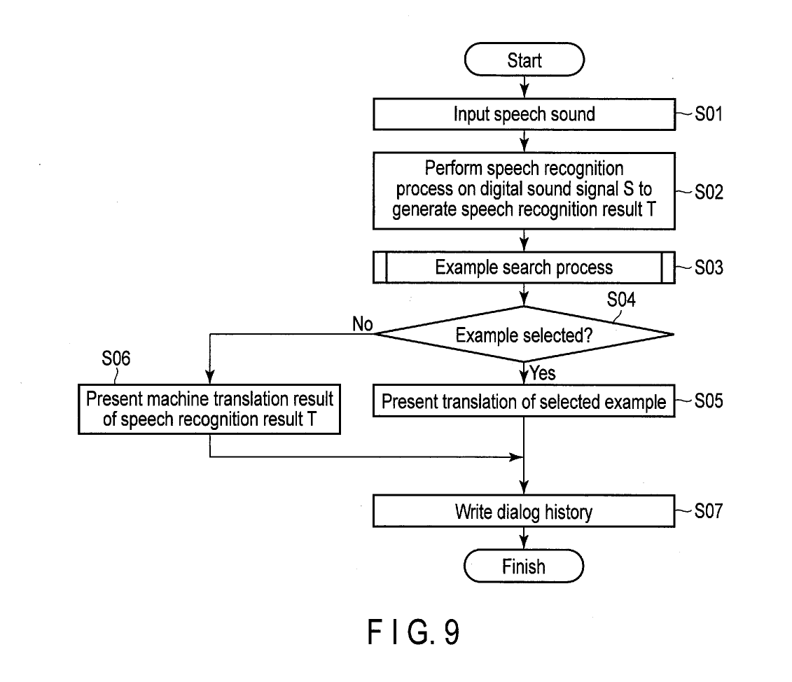

The speech translation apparatus 100 operates as shown in FIG. 9. The process of FIG. 9 begins when one of the speakers starts speaking (step S00).

The input unit 101 inputs the speech sound of a speaker in the form of digital sound signal S (step S01). The speech recognizer 102 performs a speech recognition process on the digital audio signal S input at step S01 to generate a speech recognition result T expressing the content of the speech sound (step S02). An example search process (step S03) is performed after step S02.

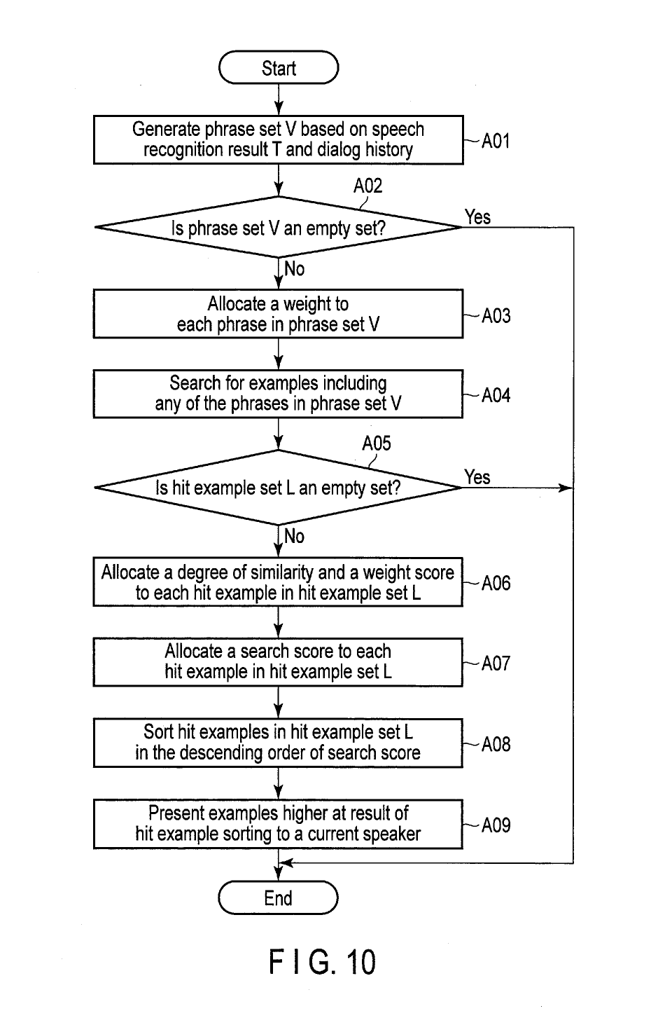

The detail of the example search process (step S03) is shown in FIG. 10. Once the example search process starts (step A00), the phrase extractor 104 extracts a phrase from a text group including the speech recognition result T generated at step S02, the past speech recognition result and the past machine translation result included in the dialog history stored in the dialog history storage 111 to generate a phrase set V (step A01).

After step A01, it is determined whether the phrase set V is an empty set or not (in other words, if no phrase is extracted at step A01 or not) (step A02). If the phrase set V is an empty set, the example search process shown in FIG. 10 is finished (step A10), and the process proceeds to step S04 of FIG. 9. On the other hand, if the phrase set V is not an empty set, the process proceeds to step A03.

At step A03, the weight allocator 105 allocates, to each of the phrases in the phrase set V generated at step A01, a weight dependent on a difference between a current dialog status and a dialog status associated with the original speech sound that corresponds to the text (i.e., a speech recognition result or a machine translation result) in which each of the phrases appears. A dialog status is, for example, a speaker of the speech sound, and the order of occurrence of the speech sound in the current dialog.

In order to generate a hit example set L, the example searcher 106 searches a plurality of examples in the first language stored in the example storage 109 for an example including one or more phrases contained in the phrase set generated at step A01 (step A04).

After step A04, it is determined whether the hit example set L is an empty set or not (in other words, if no example is searched at step A04 or not) (step A05). If the hit example set L is an empty set, the example search process in FIG. 10 is finished (step A10), and the process proceeds to step S04 of FIG. 9. On the other hand, if the hit example set L is not an empty set, the process proceeds to step A06.

At step A06, the example searcher 106 calculates a weight score for each of the hit examples included in the hit example set L generated at step A04, and the similarity calculator 107 calculates a degree of similarity between the speech recognition result T generated at step S02 and each of the hit examples included in the hit example set L.

The example sorter 108 allocates a search score obtained by performing a certain calculation based on the weight score and the degree of similarity calculated at step A06 to each hit example included in the hit example set L generated at step A04 (step A07). Furthermore, the example searcher 108 sorts the hit examples included in the hit example set L generated at step A04 in the descending order of the search scores allocated at step A07 (step A08).

The presentation unit 110 presents all or a part of the result of hit example sorting obtained at step A08 and the speech recognition result T generated at step S02 to the current speaker (step A09). After step A09, the example search process shown in FIG. 10 is finished (step A10), and the process proceeds to step S04 of FIG. 9.

At step S04, it is determined whether any of the hit examples which were output at step A09 of FIG. 9 is selected or not. If any of the hit examples is selected, the process proceeds to step S05; if not (especially when the speech recognition result T which was output at step A09 is selected), the process proceeds to step S06.

At step S05, the presentation unit 110 presents the translation of the selected example to a person to whom the current speaker is speaking. At step S06, the presentation unit 110 presents the machine translation result of the speech recognition result T generated at step S02 to the person whom the current speaker is speaking. It should be noted that a machine translation result can be generated by the machine translator 103, for example, in parallel with the example search process (step S03).

The presentation unit 110 writes the dialog history in the dialog history storage 111 (step S07). Specifically, when the process at step S05 is performed immediately before step S07, the presentation unit 110 writes information identifying the current speaker, the selected example, and the translation thereof in the dialog history storage 111. On the other hand, when the process at step S06 is performed immediately before step S07, the presentation unit 110 writes information identifying the current speaker, the speech recognition result T generated at step S02, and machine translation result in the dialog history storage 111. The process of FIG. 9 is finished after step S07 (step S08).

As explained above, the speech translation apparatus according to the first embodiment extracts a phrase from a text group including the speech recognition result of the current speech sound and the past texts contained in the dialog history, and allocates, to the extracted phrase, a weight dependent on a difference between a current dialog status and a dialog status associated with an original speech sound that corresponds to a text in which the extracted phrase appears. The speech translation apparatus uses a score calculated based on at least the above weight to select an example to be presented to the current speaker. Therefore, according to the speech translation apparatus disclosed in the present embodiment, an example suitable for the current dialog status can be prioritized to be presented.

### Second Embodiment

As explained above, the speech translation apparatus according to the first embodiment extracts a phrase from a text group including a speech recognition result of the current or past speech sound and a machine translation result of the speech recognition result. Generally, in the speech recognition process, the first candidate text that is evaluated as the most appropriate text among the plurality of candidate texts is selected as a speech recognition result, and in the machine translation process, the first candidate text that is evaluated as the most appropriate text among the plurality of candidate texts is selected as a machine translation result. The speech translation apparatus according to the second embodiment extracts a phrase even from the candidate texts that are not selected as a speech recognition result or machine translation result (i.e., the second or subsequent candidate text).

The speech translation apparatus according to the present embodiment is partially different from the speech translation apparatus 100 shown in FIG. 1 with respect to the operations at the phrase extractor 104 and the weight allocator 105.

The phrase extractor 104 receives the speech recognition result of the current speech sound in the first language and the second and subsequent candidate texts of the speech recognition result. The phrase extractor 104 further reads the dialog history from the dialog history storage 111. Specifically, the phrase extractor 104 receives a speech recognition result of a past speech sound in the first language included in the dialog history, the second and subsequent candidate texts of the speech recognition result, a machine translation result in the first language of a speech recognition result of a past speech sound in the second language, and the second and subsequent candidate texts of the machine translation result. The phrase extractor 104 extracts phrases from the text group including the above speech recognition result and the second and subsequent candidate texts of the speech recognition result, and the above machine translation result and the second and subsequent candidate texts of the machine translation result in order to obtain a set of phrases. The phase extractor 104 outputs the set of phrases to the weight allocator 105.

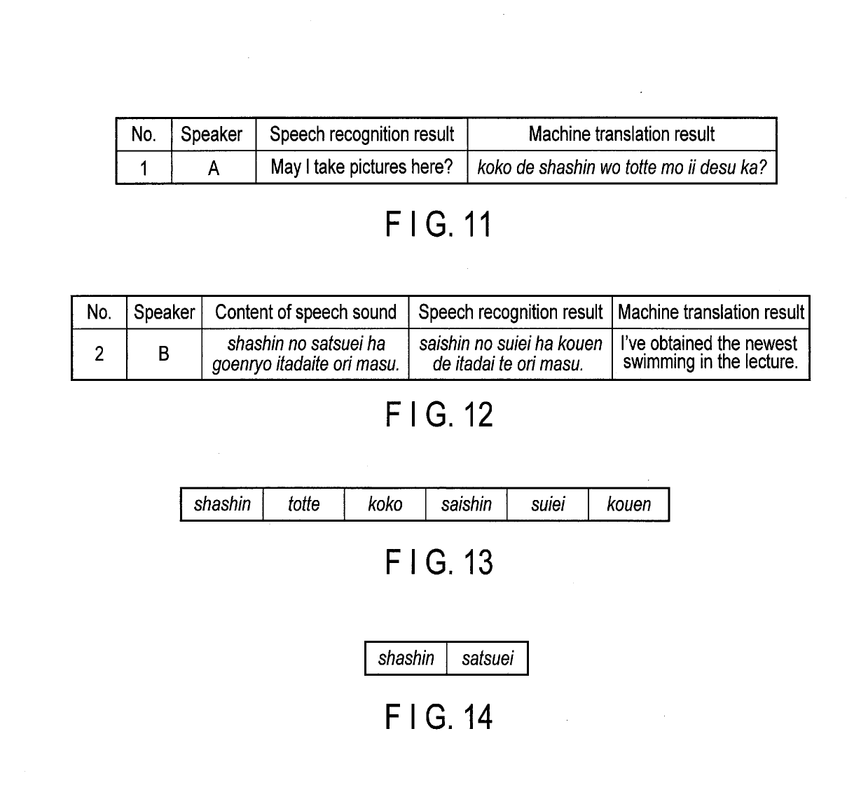

For example, the phrase extractor 104 extracts phrases from the machine translation result of the speech recognition result of the speech sound by speaker A shown in FIG. 11, and the speech recognition result of the speech sound by speaker B shown in FIG. 12 to obtain the set of phrases shown in FIG. 13. Specifically, the phrase extractor 104 extracts a phrase “shashin”, etc. from the machine translation result of the speech recognition result of the past speech sound by speaker A, and extracts “saishin”, etc. from the speech recognition result of the current speech sound by speaker B. Furthermore, as shown in FIG. 14, the phrase extractor 104 extracts a phrase “satsuei”, etc. from the second candidate text “koko de shashin satsuei wo shite mo ii desu ka?” in the machine translation result of the speech recognition result of the speech sound by speaker A shown in FIG. 11, and extracts a phrase “shashin”, etc. from the second candidate text “shashin no suiei ha kouen de itadai to ori masu.” in the speech recognition result of the speech sound by speaker B.

The weight allocator 105 receives the set of phrases from the phrase extractor 104, and reads the dialog history from the dialog history storage 111. The weight allocator 105 allocates, to each of the phrases in the phrase set, a weight dependent on a difference between a current dialog status and a dialog status associated with the original speech sound that corresponds to the phrases that appears in the text (i.e., the speech recognition result or the second and subsequent candidate texts of the speech recognition result, or the machine translation result or the second and subsequent candidate texts of the machine translation result). This weight may be adjusted in further accordance with, for example, the order of candidate texts if the text in which the phrase appears is a text of the speech recognition result or the machine translation result at the second or subsequent order.

The weight allocator 105, if a phrase appears in a plurality of texts, calculates a weight for the phrase by summing weights dependent on a difference between a dialog status associated with an original speech sound that corresponds to each of the plurality of texts and a current dialog status. The weight allocator 105 outputs the set of phrases and weights allocated to the phrases in the set to the example searcher 106.

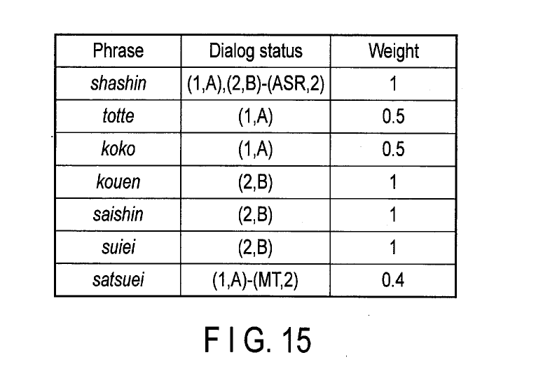

Specifically, the weight allocator 105 can allocate a weight to a phrase in the set of phrases shown in FIGS. 13 and 14 in a manner shown in FIG. 15.

The phrase “shashin” appears in the machine translation result of the speech recognition result of the speech sound at the order “1” by speaker A. The dialog status associated with the speech sound indicates that the speaker is different from that of the current dialog status, and the order of occurrence is one speech earlier than the current speech. The weight dependent on the difference of the dialog status is “0.5”. The phrase “shashin” appears in the second candidate text of the speech recognition result of the speech sound of speaker B at the order “2”, and the dialog status associated with the speech corresponds to the current dialog status. The weight dependent on the difference of the dialog status is “1.0”; however, since the phrase “shashin” appears in the second candidate text of the speech recognition result, not in the speech recognition result itself, the weight is adjusted to “0.5”. Accordingly, the weight allocator 105 allocates a weight “1.0” which is obtained by summing the weights “0.5” and “0.5” dependent on the differences of the dialog statuses to the phrase “shashin”.

The phrase “satsuei” appears in the second candidate text of the machine translation result of the speech recognition result of the speech sound of speaker A in chronological order “1”. The dialog status associated with the speech sound indicates that the speaker is different from that of the current dialog status, and the order of occurrence is one speech earlier than the current speech. The weight dependent on the difference of the dialog status is “0.5”; however, since the phrase “satsuei” appears in the second candidate text of the speech recognition result, not in the speech recognition result itself, the weight is adjusted to “0.4”. Accordingly, the weight allocator 105 allocates, to the phrase “satsuei”, a weight “0.4” dependent on the difference between these dialog statuses.

The operation of the example searcher 106, the similarity calculator 107, and the example sorter 108 is the same as those explained in the first embodiment.

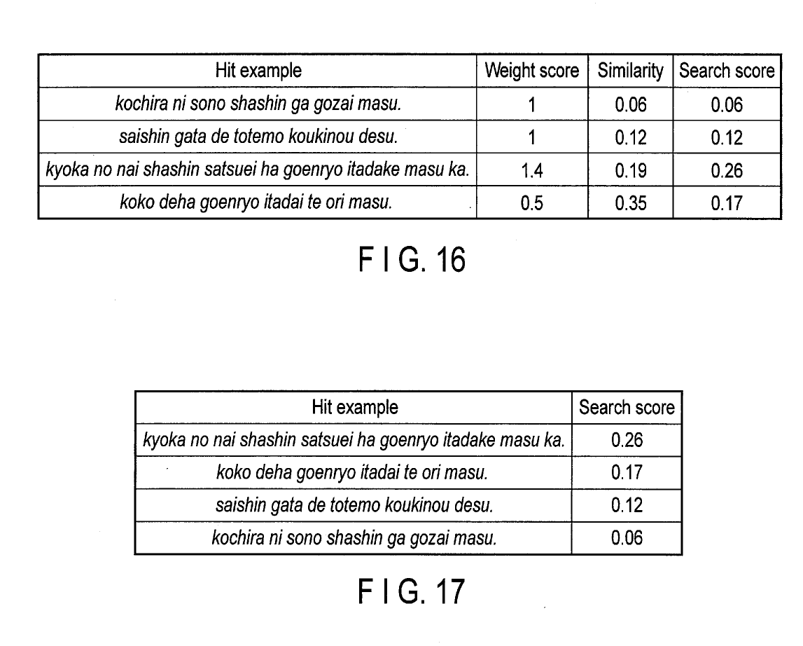

In order to obtain the set of hit examples shown in FIG. 16, the example searcher 106 searches a plurality of examples in the first language stored in the example storage 109 for a first-language example that includes one or more phrases contained in the phrase set. Furthermore, the example searcher 106 calculates a weight score for each hit example included in the hit example set, as shown in FIG. 16. The similarity calculator 107 calculates similarities between a hit example and a current speech recognition result for each hit example included in the hit example set, as shown in FIG. 16.

For example, the hit example “kyoka no nai shashin satsuei ha goenryo itadake masuka” shown in FIG. 16 includes the phrases “shasin” and “satsuei”. For this reason, the example searcher 106 sums the weight “1.0” allocated to the phrase “shasin” and the weight “0.4” allocated to the phrase “satsuei” to obtain the weight “1.4” for the above example.

The example sorter 108 allocates, to each hit example included in the hit example set, a search score obtained by performing a certain calculation based on the weight score and the degree of similarity. For example, the example sorter 108 can use a product obtained by multiplying the weight score with the degree of similarity as shown in FIG. 16 as a search score for the hit example. Then, the example sorter 108 sorts the hit examples in the descending order of search scores as shown in FIG. 17.

As explained above, the speech translation apparatus according to the second embodiment extracts a phrase from a text group including the second and subsequent candidate texts of the speech recognition result and the machine translation result, in addition to the speech recognition result and the machine translation result of the speech sound. Thus, according to the speech translation apparatus, phrases can be extracted, and weights allocated to the extracted phrases can be calculated based on a greater variety of texts, compared to the first embodiment.

At least a part of the process described in each of the foregoing embodiments can be realized using a computer as hardware. Herein, a computer is not limited to a personal computer; it may be a processing unit or any apparatus on which a program can be executed, such as a micro controller, for example. More than one computer may be used. For example, a system in which a plurality of apparatuses is connected by Internet or LAN may be adopted. It is also possible to execute at least a part of the process described in each of the foregoing embodiments with a middleware (e.g., OS, database management software, network, etc.) of a computer in accordance with instructions in a program installed on the computer.

The program to execute the above process may be stored on a computer-readable storage medium. A program is stored on a storage medium as a file in an installable or an executable format. A program may be stored on one storage medium, or may be divided into multiple storage media. A storage medium should be capable of storing a program and be computer-readable. A storage medium may be a magnetic disk, a flexible disk, a hard disk, an optical disk (such as CD-ROM, CD-R, DVD, etc.), a magneto-optical disk (MO, etc.) or a semiconductor memory.

Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A speech translation apparatus comprising:
a speech recognizer that performs a speech recognition process on a current speech sound to generate a current speech recognition result;
a machine translator that performs machine translation from a first language to a second language on the current speech recognition result to generate a current machine translation result;
a first storage that stores a dialog history for each of one or more speeches constituting a current dialog;
an extractor that extracts a phrase from a text group to obtain a set of phrases, the text group including the current speech recognition result, a past speech recognition result and a past machine translation result both included in the dialog history;
an allocator that allocates, to each of the phrases in the set of phrases, a weight dependent on a difference between a current dialog status and a dialog status associated with an original speech sound that corresponds to a text in which each of the phrases appears;
a second storage that stores a plurality of examples in the first language and translations in the second language, each of the translations corresponding to each of the examples in the first language;
a searcher that searches the plurality of examples in the first language for an example including one or more phrases included in the set of phrases to obtain a hit example set;
a calculator that calculates, for each of hit examples included in the hit example set, a degree of similarity between the hit example and the current speech recognition result; and
a sorter that calculates a score of each of the hit examples included in the hit example set based on the weight and the degree of similarity to sort the hit examples based on the score.

2. The apparatus according to claim 1, wherein the weight allocated to a given phrase is dependent on a difference between a speaker of the current speech sound and a speaker of an original speech sound that corresponds to a text in which the given phrase appears.

3. The apparatus according to claim 1, wherein the weight allocated to a given phrase is dependent on a difference between a chronological order of an original speech sound in the current dialog, the original speech sound corresponding to a text in which the given phrase appears, and a chronological order of the current speech sound in the current dialog.

4. The apparatus according to claim 1, wherein, the allocator, if a given phrase appears in a plurality of texts, calculates a weight for the given phrase by summing weights dependent on a difference between a dialog status associated with an original speech sound that corresponds to each of the plurality of texts and the current dialog status.

5. The apparatus according to claim 1, wherein the text group includes at least one of a second or subsequent candidate text of the current speech recognition result, a second or subsequent candidate text of the past speech recognition result, and a second or subsequent candidate text of the past machine translation result.

6. The apparatus according to claim 5, wherein the weight allocated to a given phrase is further dependent on a candidate order of a text in which the given phrase appears if the text is any one of the second or subsequent candidate texts of the current speech recognition result, the second or subsequent candidate texts of the past speech recognition result, and the second or subsequent candidate texts of the past machine translation result.

7. A speech translation method comprising:
performing a speech recognition process on a current speech sound to generate a current speech recognition result;
performing machine translation from a first language to a second language on the current speech recognition result to generate a current machine translation result;
storing a dialog history for each of one or more speeches constituting a current dialog;
extracting a phrase from a text group to obtain a set of phrases, the text group including the current speech recognition result, a past speech recognition result and a past machine translation result both included in the dialog history;
allocating, to each of the phrases in the set of phrases, a weight dependent on a difference between a current dialog status and a dialog status associated with an original speech sound that corresponds to a text in which each of the phrases appears;
storing a plurality of examples in the first language and translations in the second language, each of the translations corresponding to each of the examples in the first language;
searching the plurality of examples in the first language for an example including one or more phrases included in the set of phrases to obtain a hit example set;
calculating, for each of hit examples included in the hit example set, a degree of similarity between the hit example and the current speech recognition result; and
calculating a score of each of the hit examples included in the hit example set based on the weight and the degree of similarity to sort the hit examples based on the score.

8. A non-transitory computer readable storage medium storing instructions of a computer program which when executed by a computer results in performance of steps comprising:
performing a speech recognition process on a current speech sound to generate a current speech recognition result;
performing machine translation from a first language to a second language on the current speech recognition result to generate a current machine translation result;
storing a dialog history for each of one or more speeches constituting a current dialog;
extracting a phrase from a text group to obtain a set of phrases, the text group including the current speech recognition result, a past speech recognition result and a past machine translation result both included in the dialog history;
allocating, to each of the phrases in the set of phrases, a weight dependent on a difference between a current dialog status and a dialog status associated with an original speech sound that corresponds to a text in which each of the phrases appears;
storing a plurality of examples in the first language and translations in the second language, each of the translations corresponding to each of the examples in the first language;
searching the plurality of examples in the first language for an example including one or more phrases included in the set of phrases to obtain a hit example set;
calculating, for each of hit examples included in the hit example set, a degree of similarity between the hit example and the current speech recognition result; and
calculating a score of each of the hit examples included in the hit example set based on the weight and the degree of similarity to sort the hit examples based on the score.
